(19) United States
(12) Patent Application Publication
(10) Pub. No.: US 2006/0053233 A1
(43) Pub. Date: Mar. 9, 2006

(54) Method and system for implementing a remote overlay cursor

(75) Inventors: Hung-Ming Lin, Hsinchu City (TW); Ya-Cheng Chen, Hsinchu City (TW); Shu-An Huang Ho, Hsinchu City (TW)

Correspondence Address: CHARLES E. BAXLEY, ESQ., 90 JOHN STREET, THIRD FLOOR, NEW YORK, NY, 10038, US

(73) Assignee: ASPEED Technology Inc.

(21) Appl. No.: 11/262,185

(22) Filed: Oct. 28, 2005

(51) Int. Cl. G06F 15/16

(52) U.S. Cl. 709/247; 709/246

(57) ABSTRACT

A graphic display control system is disclosed. The graphic display control system comprises a server computer comprising a memory unit, a graphic display controller accessing image data displayed on the server computer and a cursor information and thereby storing the image data and the cursor information in the memory unit, a compression engine performing an image compression of the image data displayed on the server computer except a cursor pattern data of the cursor information to generate an compressed image data and thereby storing the compressed image data in the memory unit, a network controller receiving the compressed image data and the cursor information from the memory unit and transmitting the compressed image data and the cursor information through a network, and a remote client computer comprising a memory unit, a network controller receiving the compressed image data and the cursor information through the network and storing the compressed image data and the cursor information in the memory unit of the remote client computer, a decompression engine performing an image decompression of the compressed image data in the memory unit of the remote client computer to generate a decompressed image data and storing the decompressed image data in the memory unit of the remote client computer, a graphic display controller receiving the decompressed image data and displaying the decompressed image data on the remote client computer, and a cursor pattern overlay controller receiving the cursor information and overlaying the cursor information on the decompressed image data.

### BACKGROUND OF THE PRESENT INVENTION

1. Field of Invention

This invention relates to computer networks and software, and more particularly to a server computer capable of implementing a remote overlay cursor pattern displayed on a remote client computer.

2. Description of Related Arts

Referring to FIG. 1, a diagrammatic representation of a conventional computer network illustrating the interconnection of a server computer and a remote client computer is illustrated. As shown in FIG. 1, in a server computer, a graphic processor 120 comprises a graphic display controller 140 and a compression engine 150. The graphic display controller 140 is capable of accessing a content information of a web page 100, which comprises a cursor display code, a cursor information, and an HTML page containing cursor display instructions, and directly transferring the content information of a web page 100 to the compression engine 150. The compression engine 150 performs an image compression of the content information of a web page 100. The server computer is connected to Internet 160 via a modem or some other communication interface such that information may be transmitted between the server computer and Internet 160 via communication lines such as telephone cables or fiber optic networks, among other types of transmission systems. The compressed content information of a web page 100 is transferred through Internet 160. A remote client computer is connected to Internet 160 via a modem or some other communication interface such that the information may be transmitted between the remote client computer and Internet 160 via communication lines such as telephone cables or fiber optic networks, among other types of transmission systems. Accordingly, in the client remote computer, a graphic processor 130 comprises a decompression engine 170 for receiving the compressed content information of a web page 100 and performing an image decompression of the compressed content information of a web page 100. The graphic processor 130 further comprises a graphic display controller 180 for processing the decompressed content information of a web page 100 and outputting the decompressed content information 200.

Referring to FIG. 2, a diagrammatic representation of another conventional computer network illustrating the interconnection of a server computer and a remote client computer is illustrated. As shown in FIG. 2, a cursor pattern 340 is pre-stored in a memory buffer 330. In a server computer, a graphic processor 310 comprises a graphic display controller 320 for receiving image data 300 displayed on server computer and the cursor pattern data 340 and outputting a combined information of the image data 300 and the cursor pattern data 340. The graphic processor 310 further comprises a compression engine 350 for receiving the combined information of the image data 300 and the cursor pattern data 340 and performing an image compression of the combined information. The server computer is connected to Internet 360 via a modem or some other communication interface such that information may be transmitted between the server computer and Internet 360 via communication lines such as telephone cables or fiber optic networks, among other types of transmission systems. The compressed combined information of the image data 300 and the cursor pattern data 340 is transferred through Internet 360. A remote client computer is connected to Internet 360 via a modem or some other communication interface such that the information may be transmitted between the remote client computer and Internet 360 via communication lines such as telephone cables or fiber optic networks, among other types of transmission systems. Accordingly, in the client remote computer, a graphic processor 370 comprises a decompression engine 380 for receiving the compressed combined information of the image data 300 and the cursor pattern data 340 and performing an image decompression of the compressed combined information of the image data 300 and the cursor pattern data 340. The graphic processor 370 further comprises a graphic display controller 390 for processing the decompressed content information of the combined information of the image data 300 and the cursor pattern data 340 and outputting the decompressed content information 400 of the image data 300 and the cursor pattern data 340.

The major shortcoming of the above conventional computer network of a server computer and a remote client computer is that all content information of a web page comprising a cursor pattern received by a server computer should be compressed and transmitted to a remote client computer even though the position of the cursor just is moved and the other content information of a web page is the same except the cursor. This will intend to increase the loading of compression/decompression process and network transmission, thereby causing the delay of displaying the decompressed content information on the remote client computer.

In order to overcome these shortcoming, conventional techniques utilizes low-quality images to decrease the loading of compression/decompression process and network transmission or a high-performance hardware to increase the performance of compression/decompression process and network transmission, such as a high speed processor, a high bandwidth of Internet. However, a high-performance hardware such as a high speed processor is very expensive for general customers. Even though increasing the bandwidth of Internet, it is difficult to accomplish a high-quality real-time image transmission through network because multi-users share the same bandwidth of Internet.

### SUMMARY OF THE PRESENT INVENTION

It is therefore an object of the present invention to solve the foregoing problems in the conventional technology.

A main object of the present invention is to provide a server computer capable of implementing a remote overlay cursor pattern displayed on a remote client computer, in which it is possible to provide a high-quality real-time image transmission through network.

Another object of the present invention is to provide a server computer capable of implementing a remote overlay cursor pattern displayed on a remote client computer, in which it is possible to reduce the loading of compression/decompression process and network transmission, thereby preventing the delay of displaying the decompressed content information on the remote client computer.

Another object of the present invention is to provide a server computer capable of implementing a remote overlay cursor pattern displayed on a remote client computer, in which the cursor pattern could be pre-stored in the cursor pattern buffer of the remote client computer. Accordingly, the cursor pattern does not need to be transmitted from the server computer to the remote client computer once the cursor pattern has been pre-stored in the cursor pattern buffer of the remote client computer. Only the cursor location information needs to be transmitted from the server computer to the remote client computer. The loading of the data transmission could be reduced.

Another object of the present invention is to provide a server computer capable of implementing a remote overlay cursor pattern displayed on a remote client computer, in which only the cursor location information needs to be transmitted from the server computer to the remote client computer without any image compression/decompression operation if there is only the movement of the cursor and the image data displayed on the server computer does not changed. Therefore, it also will reduce the loading of the data transmission.

Accordingly, in order to accomplish the one or some or all above objects, the present invention provides a graphic display control system comprising:
a server computer comprising:
   a memory unit;
   a graphic display controller, accessing image data displayed on the server computer and a cursor information and thereby storing the image data and the cursor information in the memory unit;
   a compression engine, performing an image compression of the image data displayed on the server computer except a cursor pattern data of the cursor information to generate a compressed image data and thereby storing the compressed image data in the memory unit;
a network controller, receiving the compressed image data and the cursor information from the memory unit and transmitting the compressed image data and the cursor information through a network; and
a remote client computer comprising:
   a memory unit;
   a network controller, receiving the compressed image data and the cursor information through the network and storing the compressed image data and the cursor information in the memory unit of the remote client computer;
   a decompression engine, performing an image decompression of the compressed image data in the memory unit of the remote client computer to generate a decompressed image data and storing the decompressed image data in the memory unit of the remote client computer;
   a graphic display controller, receiving the decompressed image data in the memory unit of the remote client computer and displaying the decompressed image data on the remote client computer; and
   a cursor pattern overlay controller, receiving the cursor information in the memory unit of the remote client computer and overlaying the cursor information on the decompressed image data.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a diagrammatic representation of a conventional computer network illustrating the interconnection of a server computer and a remote client computer.

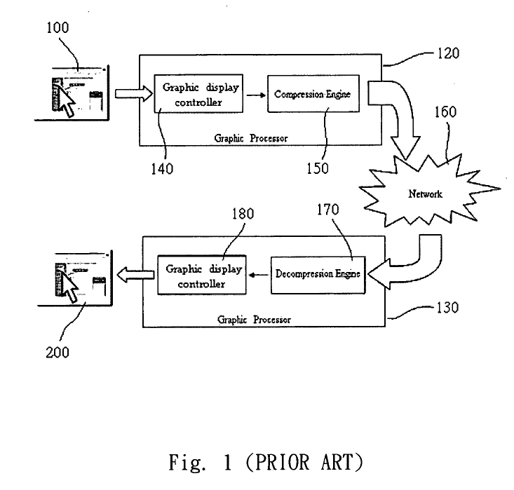

FIG. 2 illustrates a diagrammatic representation of another conventional computer network illustrating the interconnection of a server computer and a remote client computer.

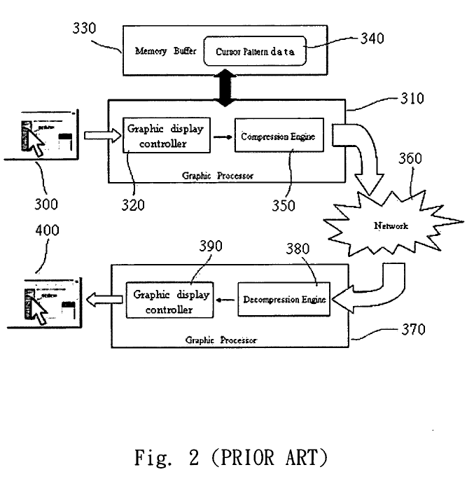

FIG. 3 is a diagrammatic representation of a computer network illustrating the interconnection of a server computer and a remote client computer according to a preferred embodiment of the present invention.

FIG. 4 is a diagrammatic representation of a computer network illustrating the interconnection of a server computer and a remote client computer according to another preferred embodiment of the present invention.

### DETAILED DESCRIPTION OF THE PREFERRED EMBODIMENT

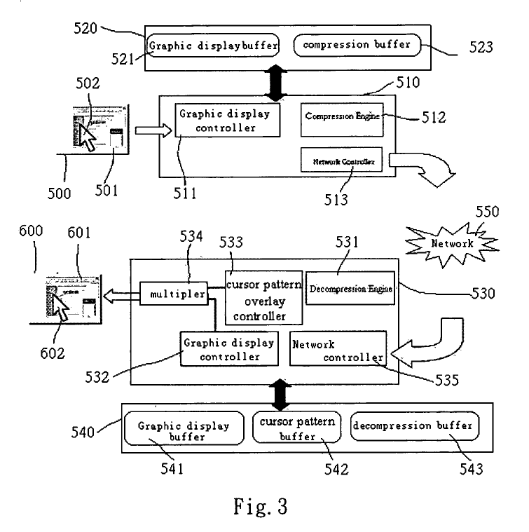

Referring to FIG. 3, a diagrammatic representation of a computer network illustrating the interconnection of a server computer and a remote client computer according to a preferred embodiment of the present invention is illustrated. As shown in FIG. 3, a server computer comprises a graphic processor 510 and a memory unit 520. The memory unit 520 comprises a graphic display buffer 521 and a compression buffer 522. The graphic processor 510 comprises a graphic display controller 511 for accessing image data displayed on the server computer and a cursor information and then storing the image data and the cursor information in the graphic display buffer 521. The cursor information comprises a cursor pattern data, a cursor visibility, and a cursor position on a screen (i.e. X-Y locations of a cursor). The graphic processor 510 further comprises a compression engine 512 for performing an image compression of the image data displayed on the server computer except the cursor pattern data and then storing the compressed image data in the compression buffer 522. The graphic processor 510 further comprises a network controller 513 for receiving the compressed image data from the compression buffer 522 and the cursor information from the graphic display buffer 521. The server computer is connected to Internet 550 via a modem or some other communication interface such that information may be transmitted between the server computer and Internet 550 via communication lines such as telephone cables or fiber optic networks, among other types of transmission systems. Accordingly, the network controller 513 transmits the compressed image data and the cursor information through Internet 550.

As shown in FIG. 3, a remote client computer comprises a graphic processor 530 and a memory unit 540. The graphic processor 530 comprises a decompression engine 531, a graphic display controller 532, a cursor pattern overlay controller 533, and a network controller 535. The memory unit 540 comprises a graphic display buffer 541, a cursor pattern buffer 542, and a decompression buffer 543. Similarly, a remote client computer is connected to Internet 550 via a modem or some other communication interface such that the information may be transmitted between the remote client computer and Internet 550 via communication lines such as telephone cables or fiber optic networks, among other types of transmission systems. Accordingly, the network controller 535 receives the compressed image data and the cursor information through Internet 550 and stores the compressed image data in the decompression buffer 543 and the cursor information in the cursor pattern buffer 542. The decompression engine 531 performs an image decompression of the compressed image data in the decompression buffer 543 and stores the decompressed image data in the graphic display buffer 541. The graphic display controller 532 receives the decompressed image data in the graphic display buffer 541 and displays the decompressed image data on the remote client computer. The cursor pattern overlay controller 533 receives the cursor information in the cursor pattern buffer 542 and overlays the cursor information on the decompressed image data displayed on the remote client computer. The graphic processor 530 further comprises a multiplexer 534 for receiving the decompressed image data and the cursor information generated by the cursor pattern overlay controller 533. Accordingly, the multiplexer 534 outputs the result 600 of the decompressed image data 601 and the cursor information 602 overlaid on the decompressed image data 601.

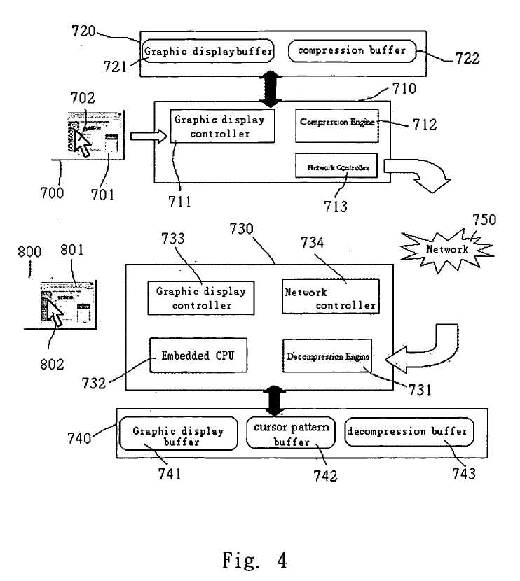

Referring to FIG. 4, a diagrammatic representation of a computer network illustrating the interconnection of a server computer and a remote client computer according to another preferred embodiment of the present invention is illustrated. In this embodiment, an embedded central processing unit (CPU) 732 is utilized instead of the multiplexer 534 and the cursor pattern overlay controller 533 as shown in FIG. 3. As shown in FIG. 4, a server computer comprises a graphic processor 710 and a memory unit 720. The memory unit 720 comprises a graphic display buffer 721 and a compression buffer 722. The graphic processor 710 comprises a graphic display controller 711 for accessing image data displayed on the server computer and a cursor information and then storing the image data and the cursor information in the graphic display buffer 721. The cursor information comprises a cursor pattern data and a cursor position (i.e. X-Y locations of a cursor). The graphic processor 710 further comprises a compression engine 712 for performing an image compression of the image data displayed on the server computer except the cursor pattern data and then storing the compressed image data in the compression buffer 722. The graphic processor 710 further comprises a network controller 713 for receiving the compressed image data from the compression buffer 722 and the cursor information from the graphic display buffer 721. The server computer is connected to Internet 750 via a modem or some other communication interface such that information may be transmitted between the server computer and Internet 750 via communication lines such as telephone cables or fiber optic networks, among other types of transmission systems. Accordingly, the network controller 713 transmits the compressed image data and the cursor information through Internet 750.

As shown in FIG. 4, a remote client computer comprises a graphic processor 730 and a memory unit 740. The graphic processor 730 comprises a decompression engine 731, the embedded central processing unit (CPU) 732, a graphic display controller 733, a, and a network controller 734. The memory unit 740 comprises a graphic display buffer 741, a cursor pattern buffer 742, and a decompression buffer 743. Similarly, a remote client computer is connected to Internet 750 via a modem or some other communication interface such that the information may be transmitted between the remote client computer and Internet 750 via communication lines such as telephone cables or fiber optic networks, among other types of transmission systems. Accordingly, the network controller 734 receives the compressed image data and the cursor information through Internet 750 and stores the compressed image data in the decompression buffer 743 and the cursor information in the cursor pattern buffer 742. The decompression engine 731 performs an image decompression of the compressed image data in the decompression buffer 743 and stores the decompressed image data in the graphic display buffer 741. The embedded central processing unit (CPU) 732 receives the cursor information in the cursor pattern buffer 742 and overlays the cursor information on the decompressed image data displayed stored in the graphic display buffer 741. Accordingly, the graphic display controller 733 receives the result 800 of the cursor information 802 overlaid on the decompressed image data 801 stored in the graphic display buffer 741 and displays the cursor information 802 overlaid on the decompressed image data 801 on the remote client computer.

According to the embodiment of the present invention as shown in the drawings and described above, the present invention provides a graphic display control method comprising the steps of:
(a) accessing image data and a cursor information displayed on a server computer;
(b) storing said image data and said cursor information in a memory unit of said server computer;
(c) performing an image compression of said image data displayed on said server computer except a cursor pattern data of said cursor information to generate an compressed image data;
(d) storing said compressed image data in said memory unit;
(e) transmitting said compressed image data and said cursor information through a network;
(f) receiving said compressed image data and said cursor information through said network and storing said compressed image data and said cursor information in a memory unit of a remote client computer;
(g) performing an image decompression of said compressed image data in said memory unit of said remote client computer to generate a decompressed image data and storing said decompressed image data in said memory unit of said remote client computer;
(h) displaying said decompressed image data on said remote client computer; and
(i) overlaying said cursor information on said decompressed image data.

The embodiment of the present invention as shown in the drawings and described above comprises a compression engine for performing an image compression of the image data displayed on the server computer except the cursor pattern data and a decompression engine for performing an image decompression of the compressed image data, however, the image compression and the image decompression are not always necessary. Hence the image data could be transmitted through the network controller without image compression/decompression. Accordingly, the cursor pattern overlay controller of the remote client computer receives the cursor information in the memory unit of the remote client computer and could overlays the cursor information on the image data.

In conclusion, the present invention provides a server computer capable of implementing a remote overlay cursor pattern displayed on a remote client computer. The cursor pattern could be pre-stored in the cursor pattern buffer of the remote client computer. The cursor pattern does not need to be transmitted from the server computer to the remote client computer once the cursor pattern has been pre-stored in the cursor pattern buffer of the remote client computer. Accordingly, only the cursor location information needs to be transmitted from the server computer to the remote client computer. The loading of the data transmission will be decreased. Furthermore, if there is only the movement of the cursor and the image data displayed on the server computer does not changed, only the cursor location information needs to be transmitted from the server computer to the remote client computer without any image compression/decompression operation. Therefore, it also will decrease the loading of the data transmission. The method and system for implementing a remote overlay cursor pattern technique may be used over virtually any wired or wireless communications channel.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A graphic display control system comprising:
a server computer comprising:
a memory unit;
a graphic display controller, accessing image data displayed on said server computer and a cursor information and thereby storing said image data and said cursor information in said memory unit;
a compression engine, performing an image compression of said image data displayed on said server computer except a cursor pattern data of said cursor information to generate an compressed image data and thereby storing said compressed image data in said memory unit; and
a network controller, receiving said compressed image data and said cursor information from said memory unit and transmitting said compressed image data and said cursor information through a network; and
a remote client computer comprising:
a memory unit;
a network controller, receiving said compressed image data and said cursor information through said network and storing said compressed image data and said cursor information in said memory unit of said remote client computer;
a decompression engine, performing an image decompression of said compressed image data in said memory unit of said remote client computer to generate a decompressed image data and storing said decompressed image data in said memory unit of said remote client computer;
a graphic display controller, receiving said decompressed image data in said memory unit of said remote client computer and displaying said decompressed image data on said remote client computer; and
a cursor pattern overlay controller, receiving said cursor information in said memory unit of said remote client computer and overlaying said cursor information on said decompressed image data.

2. The system, as recited in claim 1, wherein said memory unit of said server computer comprises:
a graphic display buffer for storing said image data and said cursor information; and
a compression buffer for storing said compressed image data.

3. The system, as recited in claim 1, wherein said memory unit of said remote client computer comprises:
a graphic display buffer for storing said decompressed image data;
a cursor pattern buffer for storing said cursor information; and
a decompression buffer for storing said compressed image data.

4. The system, as recited in claim 2, wherein said memory unit of said remote client computer comprises:
a graphic display buffer for storing said decompressed image data;
a cursor pattern buffer for storing said cursor information; and
a decompression buffer for storing said compressed image data.

5. The system, as recited in claim 1, wherein said network is selected one group of a wired communication channel, a wireless communication channel, and an internet.

6. The system, as recited in claim 4, wherein said network is selected one group of a wired communication channel, a wireless communication channel, and an internet.

7. The system, as recited in claim 1, further comprises a multiplexer receiving said decompressed image data and said cursor information generated by said cursor pattern overlay controller and outputting said cursor information overlaid on said decompressed image data.

8. The system, as recited in claim 6, further comprises a multiplexer receiving said decompressed image data and said cursor information generated by said cursor pattern overlay controller and outputting said cursor information overlaid on said decompressed image data.

9. The system, as recited in claim 1, wherein said cursor information is selected one group of a cursor position, a cursor pattern data, and a cursor visibility.

10. The system, as recited in claim 8, wherein said cursor information is selected one group of a cursor location on screen, a cursor pattern, and a cursor visibility.

11. A graphic display control system comprising:
a server computer comprising:
a memory unit;
a graphic display controller, accessing image data displayed on said server computer and a cursor information and thereby storing said image data and said cursor information in said memory unit;
a compression engine, performing an image compression of said image data displayed on said server computer except a cursor pattern data of said cursor information to generate an compressed image data and thereby storing said compressed image data in said memory unit;
a network controller, receiving said compressed image data and said cursor information from said memory unit and transmitting said compressed image data and said cursor information through a network; and
a remote client computer comprising:
a memory unit;
a network controller, receiving said compressed image data and said cursor information through said network and storing said compressed image data and said cursor information in said memory unit of said remote client computer;
a decompression engine, performing an image decompression of said compressed image data in said memory unit of said remote client computer to generate a decompressed image data and storing said decompressed image data in said memory unit of said remote client computer;
an embedded central processing unit, receiving said cursor information and overlaying said cursor information on said decompressed image data stored in said memory unit of said remote client computer; and
a graphic display controller, receiving said cursor information overlaid on said decompressed image data stored in said memory unit of said remote client computer and displaying s said cursor information overlaid on said decompressed image data on said remote client computer.

12. The system, as recited in claim 11, wherein said memory unit of said server computer comprises:
a graphic display buffer for storing said image data and said cursor information; and
a compression buffer for storing said compressed image data.

13. The system, as recited in claim 11, wherein said memory unit of said remote client computer comprises:
a graphic display buffer for storing said decompressed image data;
a cursor pattern buffer for storing said cursor information; and
a decompression buffer for storing said compressed image data.

14. The system, as recited in claim 12, wherein said memory unit of said remote client computer comprises:
a graphic display buffer for storing said decompressed image data;
a cursor pattern buffer for storing said cursor information; and
a decompression buffer for storing said compressed image data.

15. The system, as recited in claim 11, wherein said network is selected one group of a wired communication channel, a wireless communication channel, and an internet.

16. The system, as recited in claim 14, wherein said network is selected one group of a wired communication channel, a wireless communication channel, and an internet.

17. The system, as recited in claim 11, wherein said cursor information is selected one group of a cursor position, a cursor pattern data, and a cursor visibility.

18. A graphic display control system comprising:
a server computer comprising:
a memory unit;
a graphic display controller, accessing image data displayed on said server computer and a cursor information and thereby storing said image data and said cursor information in said memory unit; and
a network controller, receiving said image data and said cursor information from said memory unit and transmitting said image data and said cursor information separably through a network; and
a remote client computer comprising:
a memory unit;
a network controller, receiving said image data and said cursor information through said network separably and storing said image data and said cursor information in said memory unit of said remote client computer;
a graphic display controller, receiving said image data in said memory unit of said remote client computer and displaying said image data on said remote client computer; and
a cursor pattern overlay controller, receiving said cursor information in said memory unit of said remote client computer and overlaying said cursor information on said image data.

19. The system, as recited in claim 18, wherein said cursor information is selected one group of a cursor position, a cursor pattern data, and a cursor visibility.

20. The system, as recited in claim 18, wherein said network is selected one group of a wired communication channel, a wireless communication channel, and an internet.
